(19) United States
(12) Patent Application Publication
(10) Pub. No.: US 2013/0155450 A1
(43) Pub. Date: Jun. 20, 2013

(54) RECORDING APPARATUS HAVING A PLURALITY OF ANTENNAS

(71) Applicant: BROTHER KOGYO KABUSHIKI KAISHA, Aichi (JP)

(72) Inventor: Reiko HIGASHIKAWA, Iwakura-shi (JP)

(73) Assignee: BROTHER KOGYO KABUSHIKI KAISHA, Aichi (JP)

(21) Appl. No.: 13/626,251

(22) Filed: Sep. 25, 2012

(30) Foreign Application Priority Data
Dec. 19, 2011 (JP) 2011-276660

(51) Int. Cl. G06K 15/02; H04W 4/00

(52) U.S. Cl. 358/1.15; 455/41.2

(57) ABSTRACT

A recording apparatus includes a casing, a recording unit, and a plurality of antennas. The recording unit is accommodated in the casing and is configured to record an image on a recording medium. The plurality of antennas is provided in the casing. Each of the plurality of antennas is configured to receive, by a short-range wireless communication, data transmitted from a communication terminal brought close to the casing.

### CROSS REFERENCE TO RELATED APPLICATION

This application claims priority from Japanese Patent Application No. 2011-276660 filed Dec. 19, 2011. The entire content of the priority application is incorporated herein by reference.

### TECHNICAL FIELD

The present invention relates to a recording apparatus that records a character or an image on a recording medium.

### BACKGROUND

Recently, in the field of a recording apparatus that records an image, etc., on a recording medium, there is proposed a recording apparatus capable of performing data communication with another communication terminal by using short-range wireless communication such as NFC (Near Field Communication).

For example, a conventional printer is provided with an antenna (transmitting/receiving section) capable of performing data communication by using the short-range wireless communication. When a digital camera in which image data is stored is brought close to a side portion of a casing of the printer, the short-range wireless communication between the digital camera and printer is established, allowing the image data stored in the digital camera to be transmitted to the printer using the short-range wireless communication.

### SUMMARY

In the short-range wireless communication, a communication range of an antenna is very small. For example, in NFC, a communication distance thereof is as small as 10 cm. Further, a device such as the digital camera cannot be always brought close to the recording apparatus in the same posture, and there may be a case where transmitting/receiving may fail depending on the posture even when a distance from the recording apparatus is small. Further, in addition to the digital camera, devices (communication terminals) having various sizes and shapes, such as a mobile phone, and a smartphone, a tablet-type terminal, are considered to communicate with the recording apparatus, and a position of the antenna differs depending on the type of the communication terminals, which may bring about inappropriate positional relationship between antennas of the communication terminal and recording apparatus to cause data exchange to fail even when a user brings the communication terminal close to a predetermined portion of the recording apparatus.

An object of the present invention is to improve reliability of communication in a recording apparatus capable of performing data communication with a communication terminal by using short-range wireless communication.

In order to attain the above and other objects, there is provided a recording apparatus includes a casing, a recording unit, and a plurality of antennas. The recording unit is accommodated in the casing and is configured to record an image on a recording medium. The plurality of antennas is provided in the casing. Each of the plurality of antennas is configured to receive, by a short-range wireless communication, data transmitted from a communication terminal brought close to the casing.

### BRIEF DESCRIPTION OF THE DRAWINGS

In the drawings:

FIG. 1 is a perspective view of an ink-jet printer according to an embodiment of the present invention;

FIG. 2 is a plan view schematically illustrating an internal configuration of the ink-jet printer;

FIG. 3 is a vertical cross-sectional view thereof taken along line III-III of FIG. 2;

FIG. 4 is a plan view of the operation panel of the ink-jet printer;

FIGS. 5A and 5B are views for explaining communication between the printer and a communication terminal based on a NFC, FIG. 5A illustrating a communicable state between the printer and the communication terminal, FIG. 5B illustrating an incommunicable state between the printer and the communication terminal;

FIG. 6 is a block diagram schematically illustrating an electrical configuration of the printer;

FIG. 7 is a flowchart illustrating steps of NFC communication with the communication terminal preformed on the printer;

FIGS. 8A and 8B are cross-sectional views of one cartridge attachment portion of a holder, FIG. 8A illustrating an example in which a sensor for detecting ink residual amount is provided and FIG. 8B illustrating a sensor for detecting attachment state is provided;

FIGS. 9A and 9B are views for explaining communication between the printer and a communication terminal based on a NFC, FIG. 9A illustrating a communicable state between the printer and the communication terminal, FIG. 9B illustrating another incommunicable state between the printer and the communication terminal;

FIG. 10 is a plan view of an operation panel according to a modification to the embodiment.

### DETAILED DESCRIPTION

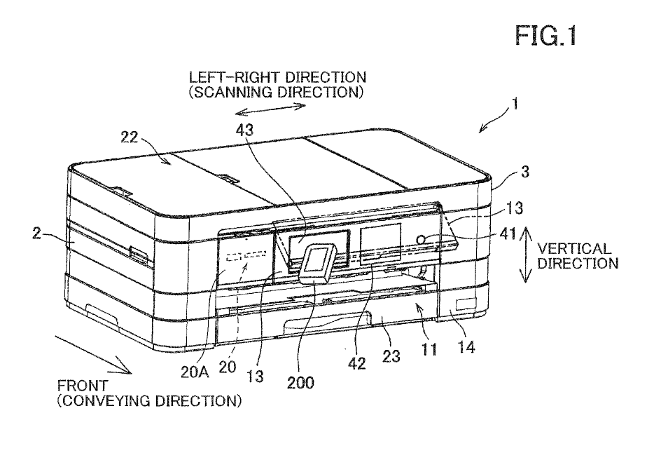

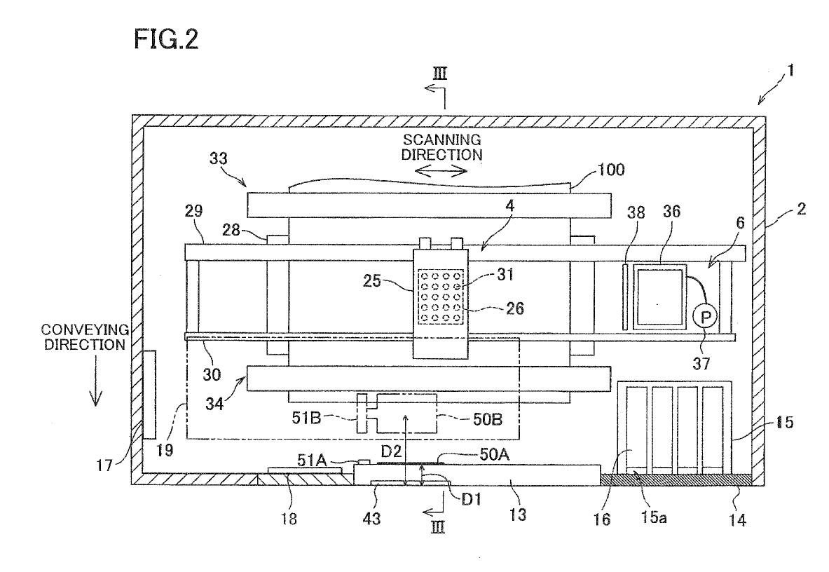

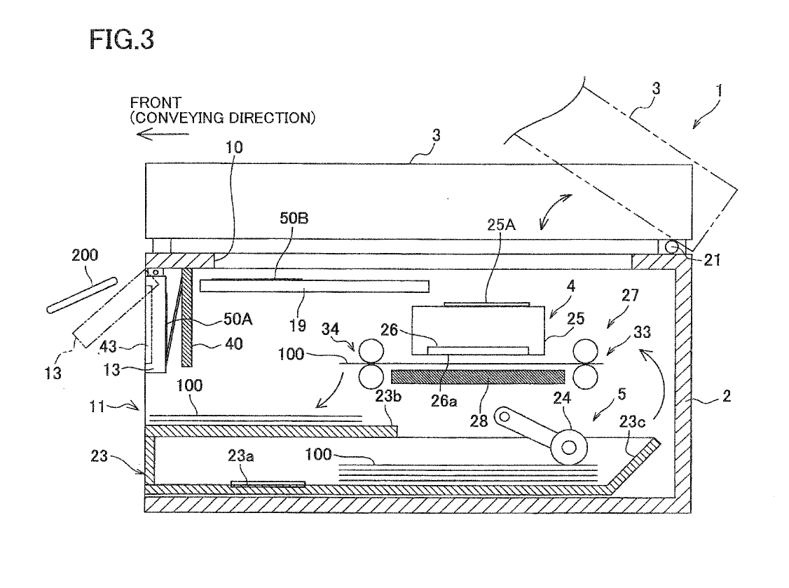

An embodiment of the present invention will be described. FIG. 1 is a perspective view of an ink-jet printer as a recording apparatus according to an embodiment of the present invention. Note that directions of upper-lower, left-right, and front-rear of the ink-jet printer are defined in an installation state of the printer illustrated in FIG. 1. FIG. 2 is a plan view schematically illustrating an internal configuration of the ink-jet printer, and FIG. 3 is a vertical cross-sectional view thereof taken along line III-III of FIG. 2.

An ink-jet printer 1 (recording apparatus) according to this embodiment can communicate with a communication terminal such as a mobile phone, a smartphone, or a tablet-type terminal using short-range wireless communication such as NFC when the communication terminal is brought close thereto as illustrated in FIG. 1. The ink-jet printer 1 is configured to receive recording data such as an image data stored in the communication terminal and record an image corresponding to the recording data onto a recording sheet (recording medium).

First, a configuration of the ink-jet printer 1 will be described. As illustrated in FIG. 1, the ink-jet printer 1 has a printer casing 2 as a casing and a cover 3. The printer casing 2 is formed of a synthetic resin material. The cover 3 is pivotally attached to the printer casing 2.

(Printer Casing)

As illustrated in FIGS. 2 and 3, the printer casing 2 contains a printer unit 4 (recording unit), a sheet supply mechanism 5, and a maintenance unit 6. The printer unit 4 records an image including a character onto a recording sheet 100. The sheet supply mechanism 5 supplies the recording sheet 100 to the printer unit 4. The maintenance unit 6 performs maintenance of an ink-jet head 26 of the printer unit 4.

As illustrated in FIG. 3, an opening 10 for jam processing and maintenance is formed at an upper end of the printer casing 2, and an attachment portion 11 to which a sheet cassette 23 of the sheet supply mechanism 5 is attached is provided at a front end of the printer casing 2.

An operation panel 13 is disposed above the attachment portion 11 and fitted to the printer casing 2 so as to be pivotable in the vertical direction. The operation panel 13 is connected by a link mechanism to a support wall 40 of the printer casing 2 disposed at a rear thereof.

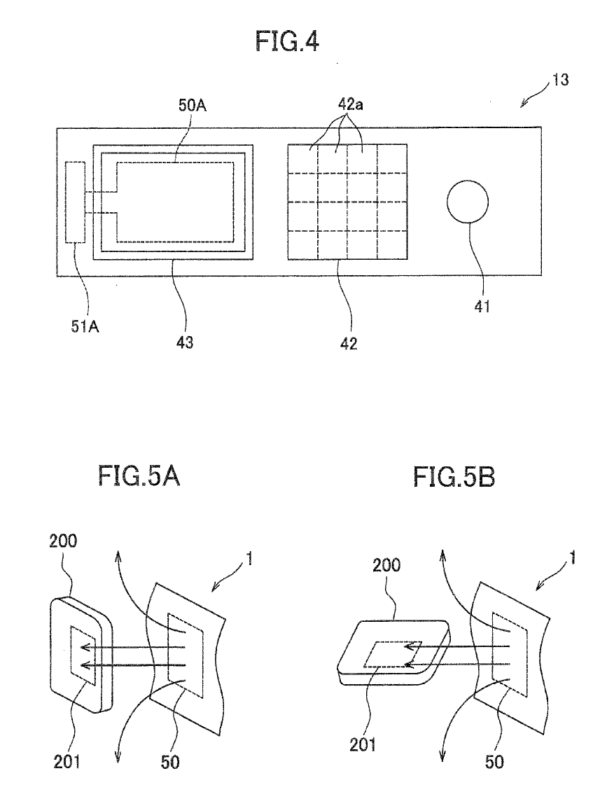

FIG. 4 is a plan view of the operation panel 13. As illustrated in FIGS. 1 and 4, the operation panel 13 has on its front surface side a power button 41, a touch panel operating portion 42 that receives user's operation, and a display 43. The operating portion 42 has a plurality of operating keys 42a including a numerical keypad which emit light at power-on time to display characters such as numeric character. The display 43 displays a message for a user and an image to be recorded. The operation panel 13 is accommodated above the attachment portion 11 in a posture that a front surface of the operation panel 13 is parallel to a vertical plane. When a user pulls the operation panel 13 frontward as illustrated in FIGS. 1 and 3, the operation panel 13 is pivoted upward to be in an inclined posture that the front surface of the operation panel 13 is inclined with respect to the vertical plane as denoted by a long dashed double-short dashed line. A pivotable angle of the operation panel 13 is less than 90° (e.g., 0° to 45°), and thus the operation panel 13 is not in a horizontal posture even when the operation panel 13 is pivoted to the maximum extent.

Thus, even when the printer 1 is placed significantly below user's eye level, pivoting the operation panel 13 in the vertical posture upward by predetermined angles makes it easy for the user to operate the operating portion 42 and to view the message or image displayed on the display 43.

Although details will be described later, as illustrated in FIGS. 2 to 4, a first loop antenna 50A is provided on a rear surface of the operation panel 13 which is opposite to the front surface thereof on which the display 43 is disposed. The first antenna 50A is capable of performing communication with a communication terminal 200 (see FIG. 1) brought close to the printer 1 by using short-range wireless communication.

An access cover 14 is fitted to a right side of the attachment portion 11 of the printer casing 2. A holder 15 to which ink cartridges 16 are attached is disposed to the back of the access cover 14. The holder 15 has four cartridge attachment portions 15a to which four ink cartridges 16 storing inks of four colors (black, yellow, cyan, and magenta) are detachably attached, respectively, from the front side.

As illustrated in FIGS. 2 and 3, a control board 19 on which various circuits for controlling the printer 1 are mounted is disposed in a horizontal posture at a position immediately rearward of the operation panel 13. Further, although details will be described later, a second loop antenna 50B is provided on an upper surface of the control board 19 at a front end thereof which is a side close to the operation panel 13. The second antenna 50B is capable of performing communication with the communication terminal 200 (see FIG. 1) brought close to the printer 1.

An electric source board 17 including an AC/DC converter is provided in the printer casing 2 to supply electrical power from an external power source to the printer unit 4, sheet supply mechanism 5, maintenance unit 6, and operation panel 13. The printer casing 2 is also provided with external media slots 20 as an external media connecting portion to which external mediums are detachably connected, the external mediums being an SD card or a Memory Stick, for example. The external media slots 20 are covered with a slot cover 20A positioned next to the operation panel 13. The user can access the external media slots 20 by opening the slot cover 20A. An external media board 18 on which a circuit for controlling the external mediums is provided in the printer casing 2.

(Cover)

The cover 3 is disposed above the printer casing 2 so as to cover the opening 10 and is attached to the printer casing 2 so as to be pivotable in the vertical direction about a pivot 21 provided at a rear end of the printer casing 2. The cover 3 can be changed in posture between a horizontally closed posture (denoted by a continuous line of FIG. 3) that closes the opening 10 of the printer casing 2 and an opened posture (denoted by a long dashed double-short dashed line) obtained by pivoting upward the cover 3 from its closed posture. Further, although details will be omitted, the cover 3 is provided with a scanner unit 22 including an image scanner that captures an image recorded on a document. Further, the cover 3 is provided with an ADF (automatic document feeder). Thus, the ink-jet printer 1 of this embodiment is designed as an all-in-one printer that can execute printing, scanning, and copying.

(Sheet Supply Mechanism)

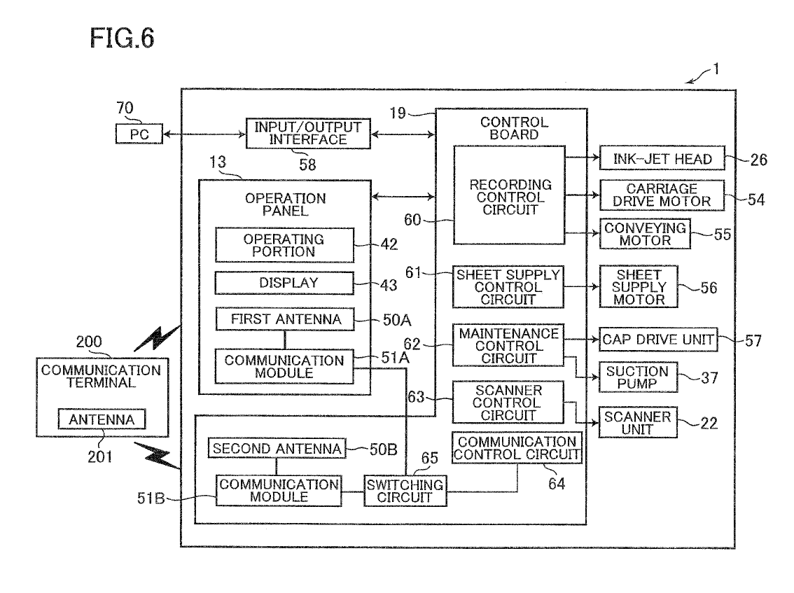

As illustrated in FIG. 3, the sheet supply mechanism 5 includes a sheet cassette 23 and a pickup roller 24. The sheet cassette 23 is attached to the attachment portion 11 of the printer casing 2. The pickup roller 24 picks up the recording sheet 100 from the sheet cassette 23. The sheet cassette 23 includes a main tray 23a and a discharge tray 23b. The main tray 23a retains therein stacked recording sheets 100. The discharge tray 23b is provided above the main tray 23a. The recording sheet 100 onto which the image, etc. has been recorded by the printer unit 4, details of which will be described later, is discharged onto the discharge tray 23b. The pickup roller 24 is disposed above the main tray 23a so as to be pivotable about a pivot provided in the printer casing 2. When driven by a sheet supply motor 56 (see FIG. 6), the pickup roller 24 picks up one by one the recording sheet 100 from the main tray 23a of the sheet cassette 23. The recording sheet 100 picked up by the pickup roller 24 is pushed upward along a slope 23c to be fed to the printer unit 4.

(Printer Unit)

The printer unit 4 is disposed above the sheet supply mechanism 5. As illustrated in FIGS. 2 and 3, the printer unit 4 includes a carriage 25, an ink-jet head 26, and a conveying mechanism 27. The carriage 25 can reciprocate in the left-right direction (scanning direction). The ink-jet head 26 is mounted on the carriage 25. The conveying mechanism 27 conveys the recording sheet 100 along the horizontal direction (conveying direction).

A carriage board 25A as a head board is disposed on an upper side of the carriage 25. The carriage board 25A is a board that controls operation of the ink-jet head 26 and is electrically connected thereto. The carriage board 25A has various electronic elements mounted on a printed circuit board thereof. The carriage board 25A is electrically connected to the control board 19. The carriage board 25A outputs an electric signal such as a drive signal in order to control the operation of the ink-jet head 26 based on an electric signal output from the control board 19.

A platen 28 that supports the recording sheet 100 is horizontally provided in the printer casing 2. As illustrated in FIG. 2, two guide rails 29 and 30 extending in parallel to the scanning direction are provided above the platen 28. The carriage 25 is driven by a carriage drive motor 54 (see FIG. 6) to move in the scanning direction along the two guide rails 29 and 30 in an area opposite to the recording sheet 100 on the platen 28.

The ink-jet head 26 is attached to a lower portion of the carriage 25 with a clearance between the ink-jet head 26 and the platen 28. A lower surface of the ink-jet head 26 serves as a droplet ejecting surface 26a having a plurality of nozzles 31. The plurality of nozzles 31 are arranged in four rows in the conveying direction to form four nozzle arrays that eject inks of four colors (black, yellow, cyan, and magenta), respectively. The ink-jet head 26 mounted on the carriage 25 is connected by tubes (not illustrated) to the above-mentioned holder 15 so as to allow the inks of four colors of the four ink cartridges 16 attached to the holder 15 to be supplied to the ink-jet head 26 through the tubes.

The ink-jet head 26 can move, together with the carriage 25, not only in the range opposite to the recording sheet 100 conveyed onto the platen 28 but also to an area outside of this range in the left-right direction. Especially, as illustrated in FIG. 2, a position outside the range opposite to the recording sheet 100 in the right direction is a stand-by position at which the carriage 25 stands by when the ink-jet head 26 is not in use, and when the carriage 25 reaches the stand-by position, the ink-jet head 26 faces the maintenance unit 6, details of which will be described later, disposed below the stand-by position.

The conveying mechanism 27 includes two conveying roller pairs 33 and 34 arranged in the front-rear direction so as to sandwich the platen 28 and carriage 25. The two conveying roller pairs 33 and 34 are driven by a conveying motor 55 (see FIG. 6) to convey the recording sheet 100 frontward (in the conveying direction) at a vertical position between the ink-jet head 26 and platen 28.

The printer unit 4 described above is designed to eject the ink from the ink-jet head 26 while moving the carriage 25 in the scanning direction (left-right direction of FIG. 1) with respect to the recording sheet 100 on the platen 28 and to convey the recording sheet 100 in the conveying direction by using the two conveying roller pairs 33 and 34 to thereby record a desired image or character onto the recording sheet 100.

(Maintenance Unit)

As illustrated in FIG. 2, the maintenance unit 6 is located at the right side of the platen 28, that is, at a position opposed to the ink-jet head 26 standing by at the stand-by position. The maintenance unit 6 includes a cap member 36, a suction pump 37, and a wiper 38.

The cap member 36 is driven to elevate by a cap drive unit 57 (see FIG. 6) constituted by a drive source such as a motor and a power transmitting mechanism such as a gear to firmly contact the liquid ejecting surface 26a of the ink-jet head 26 to thereby cover openings of the plurality of nozzles 31 (capping). The suction pump 37 is connected to the cap member 36. In a capping state of the cap member 36, the suction pump 37 sucks air in the cap member 36 to depressurize inside the cap member 36 to thereby forcibly discharge the ink from the plurality of nozzles 31 into the cap member 36 (suction purge). By discharging air bubbles or dust mixed in the ink or thickened ink by the suction purge, an occurrence of ejecting failure of the nozzles 31 can be prevented, and even if the ejecting failure of the nozzles 31 has occurred, ejecting performance thereof can be recovered.

The wiper 38 is provided to the left of the cap member 36 and wipes the ink adhered to the droplet ejecting surface 26a of the ink-jet head 26 when the ink-jet head 26 moves from the stand-by position to the platen 28.

(Configuration of Short-Range Wireless Communication Antenna)

The printer 1 of this embodiment can receive recording data such as image data from the communication terminal 200 such as a mobile phone, smartphone, PDA, or tablet device using the NFC which is a kind of short-range wireless communication, as illustrated in FIG. 1. The following describes a concrete configuration for performing such data communication.

FIGS. 5A and 5B are a view for explaining communication between the printer 1 and communication terminal 200 based on the NFC. When the communication terminal 200 is brought close to the printer 1, communication based on the NFC between a loop antenna 50 of the printer 1 and a loop antenna 201 of the communication terminal 200 is started. More specifically, when a magnetic field is generated from one of the antenna 50 of the printer 1 and antenna 201 of the communication terminal 200, induced current is generated in the other one of the antennas 50 and 201 by electromagnetic induction, causing data to be transmitted from one antenna to the other one. That is, the NFC is a kind of communication method that performs communication based on the electromagnetic induction. Alternately switching transmission (magnetic field generation) and reception (induced current generation) functions of both the antennas 50 and 201 allows two-way communication to be performed between the printer 1 and communication terminal 200.

In order to make communication possible between the antennas 50 and 201, the antennas 50 and 201 need to exist within a mutually communicable range, that is, one antenna needs to be positioned within a predetermined distance range (e.g. about 10 cm) that the magnetic flux generated in the other antenna can reach. In addition, directions (normal directions to antenna disposed planes) of the antennas 50 and 201 are important. As illustrated in FIG. 5A, when the disposed planes of the antennas 50 and 201 are parallel to each other, the magnetic flux generated in one antenna penetrates the other antenna, so that the induced current is reliably generated in the other antenna. However, as illustrated in FIG. 5B, when the disposed planes of the antennas 50 and 201 cross at right angles each other, a direction of the magnetic flux generated in one antenna and disposed plane of the other antenna become parallel to each other, resulting in a reduction in an amount of the magnetic flux that penetrates the other antenna, which disables data transmission/reception. The disposed plane represents a plane on which each of the antennas 50 and 201 is disposed.

When the communication terminal 200 is brought close to the printer 1 in a posture different from an optimum posture (in a posture parallel to the disposed plane of the antenna 50 of the printer 1, communication may fail. In this regard, a single installation of the antenna 50 on the printer 1 side is disadvantageous. Thus, in this embodiment, in order to improve reliability of communication based on the NEC, two antennas 50 that can communicate with the communication terminal 200 are provided in the printer casing 2.

As illustrated in FIGS. 2 to 4, the first antenna 50A is provided on a rear surface of the operation panel 13 at a position overlapping the display 43 in a front-rear direction. The second antenna 50B is provided on the upper surface of the control board 19 at the front end thereof which is the side close to the operation panel 13. Each of the rear surface of the operation panel 13 and the upper surface of the control board 19 corresponds to the disposed plane. The first and second antennas 50A and 50B are connected to a communication control circuit 64 (see FIG. 6) of the control board 19 through communication modules 51A and 51B each having a circuit for performing data transmission/reception.

When the communication terminal 200 is brought close to the display 43 of the operation panel 13 as illustrated in FIGS. 1 and 3, communication based on the NFC is made possible between the communication terminal 200 and the first antenna 50A on the operation panel 13 or second antenna 50B on the control board 19, allowing recording data such as image data stored in the communication terminal 200 to be received by the first antenna 50A or second antenna 50B. The display 43 corresponds to a terminal approaching target portion of this embodiment to which the communication terminal 200 is brought close. Since two antennas 50A and 50B are provided at different positions in the printer casing 2 as described above, communication can be performed using one of the antennas 50A and 50B if communication using the other one thereof fails. Further, by pivoting the operation panel 13, the direction of the first antenna 50A provided thereon can be freely adjusted to a direction suitable for receiving data from the communication terminal 20.

The operation panel 13 assumes the vertical posture and the inclined posture relative to the vertical posture, whereas the control board 19 assumes the horizontal posture. That is, regardless of the posture of the operation panel 13, the operation panel 13 and control board 19 are disposed along planes having different normal directions. Accordingly, the first antenna 50A disposed along the rear surface of the operation panel 13 and second antenna 50B disposed along the upper surface of the control board 19 always differ in direction (normal direction to the antenna disposed plane). In other words, the normal directions to the disposed plane of the first and second antennas 50A and 50B are different from each other.

Thus, as described with FIG. 5, even if communication using one antenna 50A (or 50B) fails depending on the posture of the communication terminal 200 (or on a direction of the antenna 201 on the communication terminal 200) when a user brings the communication terminal 200 close to the printer casing 2 (display 43), a possibility that communication can be performed using the other antenna 50B (or 50A) increases. For example, when the disposed plane of the antenna 201 on the communication terminal 200 and that of the first antenna 50A on the printer 1 cross at right angles each other, communication using the first antenna 50A is difficult, whereas there is a possibility that communication may be established using the second antenna 50B disposed along a plane having a different direction from a plane along which the first antenna 50A is disposed. As a result, reliability of communication is improved.

In the above configuration, the two antennas 50A and 50B are provided on two components (operation panel 13 and control board 19) of the printer 1 disposed along planes having different directions, respectively, so that addition of a special component for providing the two antennas 50A and 50B along different planes is not necessary at all.

A linear distance D1 from the first antenna 50A to the display 43 illustrated in FIG. 2 is equal to or less than a predetermined distance (e.g., about 10 cm) within which communication based on the NFC can be performed, regardless of the posture (vertical posture or inclined posture) of the operation panel 13. A linear distance D2 from the second antenna 50B to the display 43 is equal to or less than a predetermined distance (e.g., about 10 cm) within which communication based on the NFC can be performed. That is, the display 43 as the terminal approaching target portion exists within a communicable range of the first antenna 50A and within a communicable range of the second antenna 50B. Thus, when the communication terminal 200 is brought close to the display 43, data reception can be performed using any of the first and second antennas 50A and 50B.

The “communicable range” refers to a range within which communication becomes possible when the communication terminal 200 is brought close in an optimum posture in which the antenna can easily receive data and does not mean a range within which data reception can be made in any posture of the communication terminal 200. Although the second antenna 50B is disposed immediately rearward of the first antenna 50A in FIG. 2, the second antenna 50B may be displaced in a direction along the disposed plane of the first antenna 50A. However, when the second antenna 50B is excessively away from the first antenna 50A, communication becomes disabled between the communication terminal 200 brought close to the display 43 and the second antenna 50B. Thus, also in this case, the second antenna 50B should be displaced so as to allow the display 43 to fall within the communicable range of the second antenna 50B.

The following describes an electrical configuration of the printer 1, focusing on the control board 19. FIG. 6 is a block diagram schematically illustrating an electrical configuration of the printer 1. As illustrated in FIG. 6, the control board 19 that controls operation of the printer 1 is connected to a PC 70 as an external device through an input/output interface 58 so as to be able to perform data communication therewith and receives, as an input, data (recording data) such as image data or character data from the PC 70. The control board 19 is further connected with the operation panel 13 and receives, as an input, various signals concerning the operation of the printer 1 from the operation panel 13.

Various circuit including a recording control circuit 60, a sheet supply control circuit 61, a maintenance control circuit 62, a scanner control circuit 63, and the communication control circuit 64 are mounted on the control board 19. The recording control circuit 60 controls recording operation of the printer unit 4 that has the jet-ink head 26 based on received recording data. The sheet supply control circuit 61 controls sheet supply operation of the sheet supply mechanism 5. The maintenance control circuit 62 controls maintenance operation (suction purge, etc.) of the maintenance unit 6. The scanner control circuit 63 controls image capture operation of the scanner unit 22. The communication control circuit 64 controls NFC data communication with the communication terminal 200.

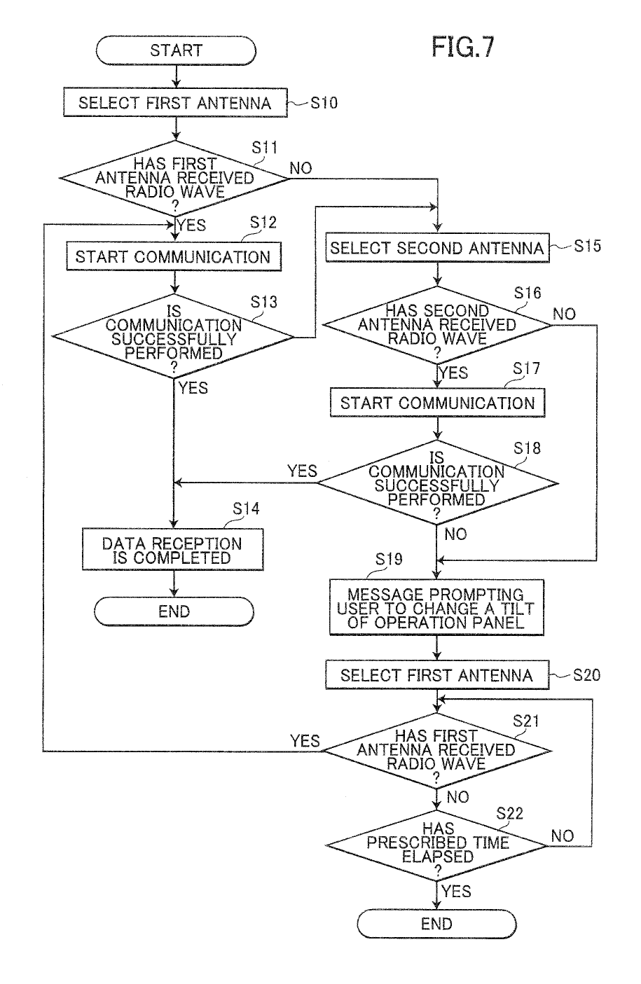

The following describes the NFC communication (reception of recording data) to be controlled by the communication control circuit 64 in detail with reference to the block diagram of FIG. 6 and a flowchart of FIG. 7. As illustrated in FIG. 6, the communication control circuit 64 is connected to the communication modules 51A and 51B of the first and second antennas 50A and 50B, respectively, through a switching circuit 65 and controls communication by means of the first antenna 50A and communication by means of the second antenna 50B. The switching circuit 65 (switching unit) is a circuit that selectively switches the antenna that receives recording data from the communication terminal 200 between the first antenna 50A and the second antenna 50B.

A specific portion (terminal approaching target portion) of the printer casing 2 to which the communication terminal 200 is brought close for establishing communication between the printer 1 and communication terminal 200 is previously set. In this embodiment, the terminal approaching target portion is the display 43 of the operation panel 13 attached to the printer casing 2. In order to allow a user to recognize that the terminal approaching target portion is the display 43, a mark or a message representing the terminal approaching target portion may be attached in the vicinity of the display 43. Alternatively, when the NFC communication is started, a message saying “hold the communication terminal 200 over the display 43” may be displayed on this display 43.

After a user selects recording data at the communication terminal 200, the NFC communication with the communication terminal 200 is started by the printer 1 when a user operates the operating portion 42 of the operation panel 13 to input a predetermined instruction. In this embodiment, the first antenna 50A provided on the operation panel 13 has priority over the second antenna 50B in terms of reception of the recording data. That is, when the communication start instruction is input, the communication control circuit 64 controls the switching circuit 65 to select the first antenna 50A so as to connect the communication module 51A to the communication control circuit 64 (S10). Next, the communication control circuit 64 controls the first antenna 50A to generate a magnetic field therefrom. If the communication terminal 200 is brought close by the user to the display 43 as the terminal approaching target portion, the communication terminal 200 outputs radio wave in response to the magnetic field generated from the first antenna 50A. In S11, the communication control circuit 64 determines whether or not the first antenna 50A has received radio wave transmitted from the communication terminal 200 brought close by the user to the display 43. The communication control circuit 64 determines that the first antenna 50A has received radio wave (S11: Yes), the communication control circuit 64 controls the communication module 51A to allow communication to be performed between the first antenna 50A and communication terminal 200 (S12). That is, data reception using the first antenna 50A is started. The communication terminal 200 transmits the recording data to the printer through the first antenna 50A. When the communication control circuit 64 determines that communication using the first antenna 50A is successfully performed (S13: Yes), reception of the recording data is completed (S14) and communication with the communication terminal 200 is terminated.

On the other hand, when the communication control circuit 64 determines that the first antenna 50A has failed to receive the radio wave from the communication terminal 200 (S11: No), the communication control circuit 64 controls the switching circuit 65 to select the second antenna 50B so as to connect the communication module 51B to the communication control circuit 64 (S15). Also in a case where the communication control circuit 64 determines that the first antenna 50A has failed to receive normally the recording data due to abnormality occurring in the middle of communication (S13: No), the communication control circuit 64 control the switching circuit 65 to select the second antenna 50B (S15). For example, when the number of times of interruption of communication is equal to or more than a certain number, or a time during which communication is interrupted is equal to or more than a certain period of time, communication using the first antenna 50A is determined to be abnormal.

When the communication control circuit 64 confirms that the radio wave transmitted from the control terminal 200 has been received by the second antenna 50B (S16: Yes), the communication control circuit 64 controls the communication module 51B to allow communication to be performed between the second antenna 50B and communication terminal 200 (S17). When the communication control circuit 64 determines that communication using the second antenna 50B is successfully performed (S18: Yes), reception of the recording data is completed (S14).

When the communication control circuit 64 confirms that the second antenna 50B has failed to receive the radio wave from the communication terminal 200 (S16: No), or when the second antenna 50B has failed to receive normally the recording data due to abnormality occurring in the middle of communication (S18: No), a message prompting the user to change a tilt of the operation panel 13 is displayed on the display 43 in order to change the direction of the first antenna 50A (S19).

In S19, in place of the massage prompting the user to change the tilt of the operation panel 13, a message prompting the user to change a position or posture of the communication terminal 200 may be displayed. Then, in the anticipation that the user changes the position or posture of the communication terminal 200 after the display of the message, the communication control circuit 64 controls the switching circuit 65 to select the first antenna 50A so as to connect the communication module 51A to the communication control circuit 64 (S20). Then, when the first antenna 50A has received the radio wave from the communication terminal 200 (S21: Yes) after the display of the message, data reception using the first antenna 50A is started (S12). On the other hand, when the first antenna 50A has failed to receive the radio wave from the communication terminal 200 (S21: No), the communication control circuit 64 determines whether or not a certain period of time has been elapsed after the first antenna 50A was selected by the switching circuit 65 in S20 (S22). When the communication control circuit 64 determines that a certain period of time has not been elapsed (S22: No), the communication control circuit 64 returns to S21. On the other hand, when the communication control circuit 64 determines that a certain period of time has not been elapsed (S22: Yes), communication with the communication terminal 200 is terminated.

The recording data thus received by the first antenna 50A or second antenna 50B is transferred from the communication control circuit 64 to the recording control circuit 60 as in the case where the recording data is received from the PC 70. Thereafter, the recording operation of the printer unit 4 is controlled based on the recording data.

The printer 1 of this embodiment described above has the two antennas 50A and 50B each of which is capable of performing the NFC communication with the communication terminal 200. Further, the directions (normal directions to antenna disposed planes) of the two antennas 50A and 50B differ from each other. Thus even if communication using one antenna fails depending on the posture of the communication terminal 200, a possibility that communication can be performed using the other antenna increases, thereby improving reliability of communication.

The switching circuit 65 preferentially selects the first antenna 50A and, when communication using the first antenna 50A has failed, automatically switches the antenna to be used for data reception to the second antenna 50B. The switching circuit 65 may preferentially select the second antenna 50B provided on the control board 19. However, in this embodiment, the operation panel 13 that receives user's operation is provided on a front surface of the printer casing 2 for ease of access, which allows the communication terminal 200 to be easily brought close to the first antenna 50A. On the other hand, the control board 19 is disposed inside the printer casing 2 and rearward of the operation panel 13. Thus, as compared to the first antenna 50A, the second antenna 50B cannot receive well the recording data from the communication terminal 200 brought close to the front surface of the operation panel 13. For these reasons, the antenna used preferentially to receive the recording data is preferably the first antenna 50A provided on the operation panel 13.

The following describes modifications obtained by adding various kinds of changes to the embodiment given above. The same reference numerals are given to the same parts as those already described in the above-mentioned embodiment, and duplicate description therefore is appropriately omitted.

[1] In the above embodiment, the operation panel 13 is pivoted with respect to the printer casing 2 manually by a user. Alternatively, however, the operation panel 13 may be driven to be pivoted by an actuator such as a motor. In this case, in the flowchart of FIG. 7, when both the first and second antennas 50A and 50B fail to receive the recording data, the tilt (i.e., direction of the first antenna 50A) of the operation panel 13 can automatically be changed by the actuator, thus eliminating the need to display the message prompting the user to change the tilt of the operation panel 13 in S19.

The present invention may be applied to a case where the operation panel 13 is fixed to the printer casing 2 in a non-pivotable manner. In this case, the direction of the first antenna 50A cannot be changed, so that when both the first and second antennas 50A and 50B fail to receive the recording data, reception of the recording data is terminated at that time, or the message prompting the user to change the position or posture of the communication terminal 200 is displayed on the display 43.

[2] In the above embodiment, there are provided the two antennas 50A and 50B in the printer casing 2. Alternatively, however, three or more antennas may be provided in the printer casing 2 since reliability of communication with the communication terminal 200 is improved more as the number of the antennas to be used is increased. Further, the directions (normal directions to antenna disposed planes) of the three or more antennas preferably differ from each other. An example of such an embodiment will be described below.

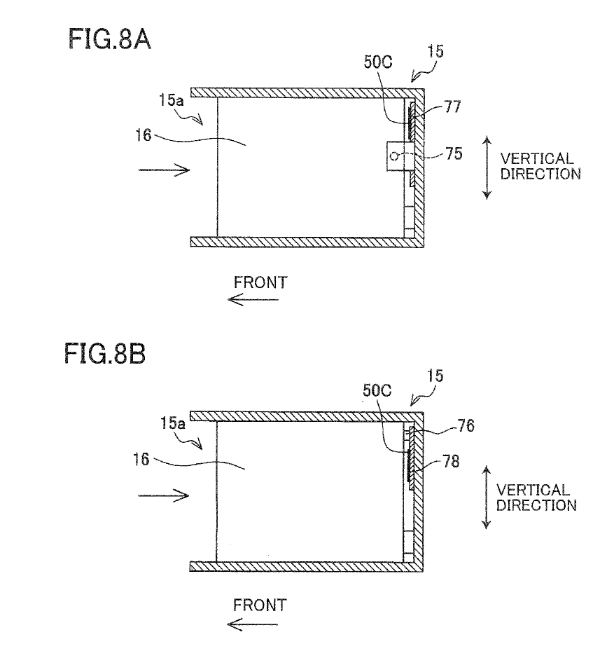

There may be a case where the holder 15 illustrated in FIG. 2 is provided with a sensor for detecting an ink residual amount or a sensor for detecting an attachment state. In this case, a detection board on which a circuit for processing an output signal from such a sensor is mounted is disposed near the sensor. FIGS. 8A and 8B are cross-sectional views of one cartridge attachment portion 15a of the holder 15. FIG. 8A illustrates an example in which a sensor 75 for detecting the ink residual amount is provided. FIG. 8B illustrates an example in which a sensor 76 for detecting the attachment state is provided. The type of the sensor used as the sensors 75 and 76 is not especially limited. For example, as the sensor 75 for detecting the ink residual amount of FIG. 8A, an optical sensor may be used. Further, as the sensor 76 for detecting the attachment state of FIG. 8B, an electric contact sensor may be used.

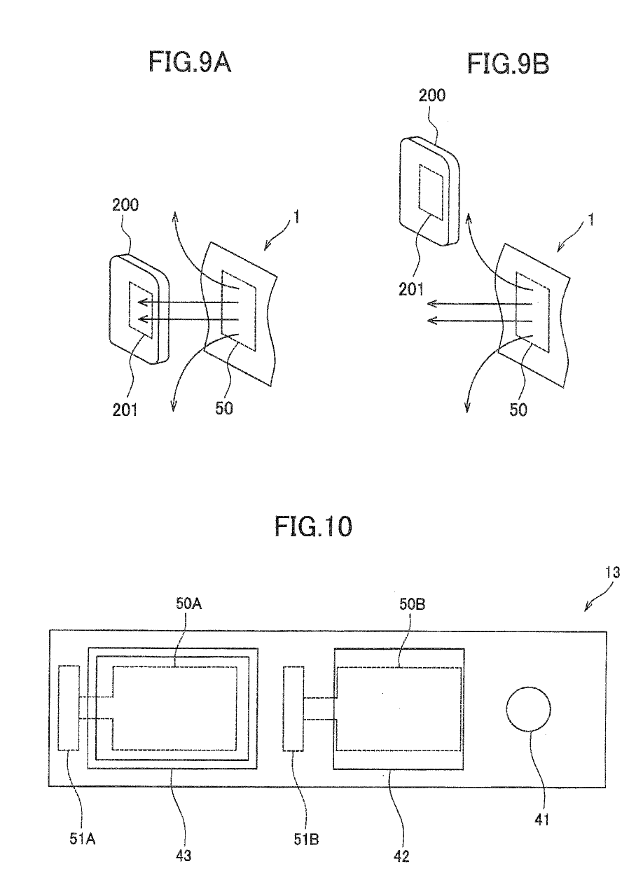

In FIGS. 8A and 8B, cartridge attachment portion 15a of the holder 15 receives the ink cartridge 16 from its opened front side. In this configuration, the sensors 75 and 76 are generally disposed on the back side of the ink cartridge 16 which is an attachment direction leading end side thereof. That is, as illustrated in FIGS. 8A and 8B, detection boards 77 and 78 to be connected respectively to the sensors 75 and 76 are each disposed on a back side wall surface of the holder 15 in a vertical posture. Thus, when the operation panel 13 is inclined relative to the vertical plane in the above embodiment, the detection boards 77 and 78 are each disposed along a plane having a different normal direction from those of the inclined operation panel 13 on which the first antenna 50A is provided and horizontally-disposed control board 19 on which the second antenna 50B is provided. Therefore, by providing a third antenna 50C different from the first and second antennas 50A and 50B on the detection board 77 or 78, the directions of the three antennas 50A, 50B, and 50C differ from each other, thereby further improving reliability of communication with the communication terminal 200.

[3] The disposed position of the antenna 50 is not limited to the above described operation panel 13, control board 19, or detection board 77 or 78. There are provided various sensors other than those described above in the printer 1, so that the antenna 50 may be provided on a circuit board corresponding to each sensor. For example, the antenna 50 (50B) may be provided on the electric source board 17, the external media board 18, or the carriage board 25A. Further, the antenna 50 need not always be provided on the circuit board but may directly be provided on an inner wall surface or an outer wall surface of the printer casing 2, the sheet cassette 23, or the scanner unit 22.

[4] As has been already stated, when the disposed plane of the antenna 50 of the printer 1 and that of the antenna 201 of the communication terminal 200 are parallel to each other as illustrated in FIG. 9A, communication is possible between the antennas 50 and 201. However, even in this state, when the position of the communication terminal 200 is away from a proper position corresponding to the antenna 50 of the printer 1 to prevent the antennas 50 and 201 from overlapping each other as illustrated in FIG. 9B, a direction of magnetic flux generated in one antenna becomes parallel to the disposed plane of the other antenna, thus disabling communication.

In view of the above, a plurality of antennas the disposed planes of which are parallel to each other may be provided. Further, the plurality of antennas may be displaced from each other. For example, in FIG. 10, the first and second antennas 50A and 50B are disposed on different positions on the operation panel 13. That is, the positions of the first and second antennas 50A and 50B are displaced from each other as viewed from a direction perpendicular to the disposed plane. In this configuration, even when the communication terminal 200 is brought close to a position away from the display 43 as the terminal approaching target portion and thus the first antenna 50A disposed on a position overlapping the display 43 fails to receive the recording data, the second antenna 50B displaced from the position of the first antenna 50A can receive the recording data, thus improving reliability of communication.

[5] A predetermined position (terminal approaching target portion) of the printer casing 2 to which the user brings close the communication terminal 200 is not limited to the display 43 on the operation panel 13. For example, the terminal approaching target portion may be the operating portion 42 provided on the same operation panel 13. Alternatively, the terminal approaching target portion may be a portion away from the operation panel 13, such as the cover 3 having the scanner unit 22.

However, the terminal approaching target portion needs to exist within a communicable range of at least one antenna 50 (preferably, communicable ranges of all the antennas 50). In other words, the disposed positions of the antenna 50 is determined first, and then the terminal approaching target portion is set to a portion within the communicable range of the antenna 50. Conversely, the terminal approaching target portion is set to a portion easily-accessible from the user first, and then the antenna 50 is set so as to allow the terminal approaching target portion to fall within the communicable range thereof.

[6] In the above embodiment, the switching circuit 65 is used to select one of the first and second antennas 50A and 50B as the antenna that receives the recording data. Alternatively, however, in a state where two or more antennas 50 can communicate with the communication terminal 200, all the antennas 50 that can communicate with the communication terminal 200 may be used to receive the recording data simultaneously.

[7] In the above embodiment, the recording data is transmitted from the communication terminal 200 to the printer 1 during the communication in S12 and S17. Alternatively, however, communication setting data including IP address of the printer 1 may be transmitted from the printer 1 to the communication terminal 200 during the communication in S12 and 17. In this case, reception of the radio wave output from the communication terminal 200 in S11 serves as a trigger to transmit the communication setting data from the printer 1 to the communication terminal 200. When the communication setting data is set in the communication terminal, the printer 1 becomes available to the communication terminal 200.

[8] In the above embodiment, the recording data is transmitted from the communication terminal 200 to the printer 1 via the NFC communication therebetween. However, if the printer casing 1 and the communication terminal 200 can communicate with each other by using a wireless LAN, the recording data may be transmitted from the communication terminal 200 to the printer through the wireless LAN. In this case, reception of the radio wave output from the communication terminal 200 in S11 serves as a trigger to transmit the recording data from the printer 1 to the communication terminal 200 by using the wireless LAN.

What is claimed is:

1. A recording apparatus comprising:
a casing;
a recording unit accommodated in the casing and configured to record an image on a recording medium;
a plurality of antennas provided in the casing and each of which is configured to receive, by a short-range wireless communication, data transmitted from a communication terminal brought close to the casing.

2. The recording apparatus according to claim 1, wherein the plurality of antennas is provided in the casing such that normal directions to disposed planes of the plurality of antennas are different from one another.

3. The recording apparatus according to claim 2, further comprising:
an operation panel attached to the casing and configured to receive a user's operation; and
a control board provided in the casing and configured to control a recording operation of recording unit, and
wherein the operation panel and the control board are disposed along planes having different normal directions,
wherein the plurality of antennas includes a first antenna disposed on the operation panel to receive, by the short-range wireless communication, data transmitted from the communication terminal brought close to the casing, and a second antenna disposed on the control board to receive, by the short-range wireless communication, data transmitted from the communication terminal brought close to the casing.

4. The recording apparatus according to claim 3, further comprising a switching unit configured to preferentially select one of the first and second antennas to receive data from the communication terminal, and to switch the one of the first and second antennas to the other of the first and second antennas to receive data from the communication terminal when the one of the first and second antennas has failed to receive data from the communication terminal.

5. The recording apparatus according to claim 4, wherein the switching unit is configured to preferentially select the first antenna to receive data from the communication terminal.

6. The recording apparatus according to claim 3, wherein the casing has a terminal approaching target portion to which the communication terminal is brought close,
wherein a distance from the first antenna to the terminal approaching target portion and a distance from the second antenna to the terminal approaching target portion are equal to or less than a predetermined distance within which the communication terminal is allowed to communicate with one of the first antenna and the second antenna.

7. The recording apparatus according to claim 3, wherein the operation panel is pivotally attached to the casing.

8. The recording apparatus according to claim 3, wherein the recording unit includes an ink-jet head configured to eject an ink droplet,
wherein the casing is provided with a cartridge attachment portion to which an ink cartridge storing ink used in the ink-jet head is detachably attached,
wherein the cartridge attachment portion is provided with a detection board configured to detect ink residual amount in the ink cartridge, the detection board being disposed along a plane having a normal direction different from the normal directions to the planes along which the operation panel and the control board are disposed,
wherein the plurality of antennas includes a third antenna disposed on the detection board to receive, by the short-range wireless communication, data transmitted from the communication terminal brought close to the casing.

9. The recording apparatus according to claim 2, further comprising:
an operation panel attached to the casing and configured to receive a user's operation; and
an electric source board configured to supply electrical power from an external power source to the recording unit,
wherein the operation panel and the electric source board are disposed along planes having different normal directions,
wherein the plurality of antennas includes a first antenna disposed on the operation panel to receive, by the short-range wireless communication, data transmitted from the communication terminal brought close to the casing, and a second antenna disposed on the electric source board to receive, by the short-range wireless communication, data transmitted from the communication terminal brought close to the casing.

10. The recording apparatus according to claim 2, further comprising:
an operation panel attached to the casing and configured to receive a user's operation;
an external media connecting portion to which an external storage medium is detachably connected; and
an external media board configured to control the external storage medium connected to the external media connecting portion,
wherein the operation panel and the external media board are disposed along planes having different normal directions,
wherein the plurality of antennas includes a first antenna disposed on the operation panel to receive, by the short-range wireless communication, data transmitted from the communication terminal brought close to the casing, and a second antenna disposed on the external media board to receive, by the short-range wireless communication, data transmitted from the communication terminal brought close to the casing.

11. The recording apparatus according to claim 2, further comprising:
an operation panel attached to the casing and configured to receive a user's operation, and
wherein the recording unit includes an ink-jet head configured to eject ink to form the image on the recording medium, and a head board configured to control an ink ejection operation of the ink-jet head,
wherein the operation panel and the head board are disposed along planes having different normal directions,
wherein the plurality of antennas includes a first antenna disposed on the operation panel to receive, by the short-range wireless communication, data transmitted from the communication terminal brought close to the casing, and a second antenna disposed on the head board to receive, by the short-range wireless communication, data transmitted from the communication terminal brought close to the casing.

12. The recording apparatus according to claim 1, wherein the plurality of antennas is provided in the casing such that disposed planes of the plurality of antennas are parallel to one another and positions of the plurality of antennas are displaced from one another as view from a direction perpendicular to the disposed planes.
